(19) United States
(12) Patent Application Publication
(10) Pub. No.: US 2018/0060092 A1
(43) Pub. Date: Mar. 1, 2018

(54) Group Data and Priority in an Individual Desktop

(71) Applicant: Microsoft Technology Licensing, LLC, Redmond, WA (US)

(72) Inventors: Matthias Baer, Seattle, WA (US); Alice Jane Bernheim Brush, Bellevue, WA (US); Terri Lynne Chudzik, Seattle, WA (US); Peter G. Davis, Kirkland, WA (US); Abolade Gbadegesin, Sammamish, WA (US); Naveen K. Yajaman, Redmond, WA (US)

(73) Assignee: Microsoft Technology Licensing, LLC, Redmond, WA (US)

(21) Appl. No.: 15/430,206

(22) Filed: Feb. 10, 2017

Related U.S. Application Data
(60) Provisional application No. 62/382,165, filed on Aug. 31, 2016.
(60) Provisional application No. 62/382,142, filed on Aug. 31, 2016.

(51) Int. Cl. G06F 9/44; G06F 3/14; G06F 3/0484

(52) U.S. Cl. CPC G06F 9/4445; G06F 3/04847; G06F 3/1454

(57) ABSTRACT

Techniques for a group data and priority in an individual desktop are described. In at least some implementations, content associated with a group identity is presented in an individual desktop based on priority settings. According to various implementations, priority settings are determined for each user of a group based on an individual identity for each user and the group identity. Thus, a group of users can interact with content associated with the group identity in an individual environment.

### RELATED APPLICATIONS

This application claims priority under 35 U.S.C. Section 119(e) to U.S. Provisional Application Ser. No. 62/382,165 entitled “Group-Powered Individual Desktop,” and to U.S. Provisional Application Ser. No. 62/382,142 entitled “Shared Family Desktop,” both of which were filed on Aug. 31, 2016, the disclosures of which are incorporated by reference herein in their entirety.

### BACKGROUND

Today's connected environment enables individuals to interact in a variety of different ways. Individuals typically interact among one another using separate computing devices each of which is often associated with a single personal identity. Interactions by individuals can include presenting content related to their personal identity on a desktop platform. However, traditional ways for interacting on an individual desktop platform do not enable group interactions in an efficient manner which can lead to user frustration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for group data and priority in an individual desktop are described. In at least some implementations, content associated with a group identity is presented in an individual desktop based on priority settings. According to various implementations, priority settings are determined for each user of a group based on an individual identity for each user and the group identity. Thus, a group of users can interact with content associated with the group identity in an individual environment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Identical numerals followed by different letters in a reference number may refer to different instances of a particular item.

FIG. 1 is an illustration of an environment in an example implementation that is operable to employ techniques discussed herein.

FIG. 2 depicts an example implementation scenario for configuring a group identity with individual identities and priority settings in accordance with one or more embodiments.

FIG. 3 depicts an example implementation scenario for presenting a shared desktop in an individual desktop in accordance with one or more embodiments.

FIG. 4 depicts an example implementation scenario for integrating group data in an individual desktop in accordance with one or more embodiments.

FIG. 5 depicts an example implementation scenario for an identity switching control for groups in accordance with one or more embodiments.

FIG. 6 depicts an example implementation scenario for a task-switching control for groups in accordance with one or more embodiments.

FIG. 7 is a flow diagram that describes steps in a method for interacting with group data in an individual desktop in accordance with one or more embodiments.

FIG. 8 is a flow diagram that describes steps in a method for processing group data in an individual processing system in accordance with one or more embodiments.

FIG. 9 is a flow diagram that describes steps in a method for integrating group data in an individual desktop in accordance with one or more embodiments.

FIG. 10 illustrates an example system and computing device as described with reference to FIG. 1, which are configured to implement embodiments of techniques described herein.

### DETAILED DESCRIPTION

### Overview

Techniques for group data and priority in an individual desktop are described. In at least some implementations, content associated with a group identity is presented in an individual desktop based on priority settings. According to various implementations, priority settings are determined for each user of a group based on an individual identity for each user and the group identity. Thus, a group of users can interact with content associated with the group identity in an individual environment.

According to various implementations, an individual identity is validated and an individual desktop is presented to a user. A group platform module identifies a group identity associated with the user. The group identity is associated with the individual identity of the user, as well as the individual identities of other users from the same group. Priority settings are determined for each user in the group, relative to one another.

In some implementations, an interactive portion or visual selector is presented on the individual desktop to enable interaction with or presentation of a shared desktop or content associated with the group identity. The shared desktop may be presented in addition to or instead of the individual desktop and content may be shared between the individual desktop and shared desktop through the group identity.

According to various implementations, content related to the group identity is aggregated and integrated with content associated with the individual identities from the group based on the priority settings. In some implementations, the prioritized content is integrated into applications and/or services from the individual desktop. Integrated and prioritized content may then be presented for interaction through the individual identity.

Example Environment

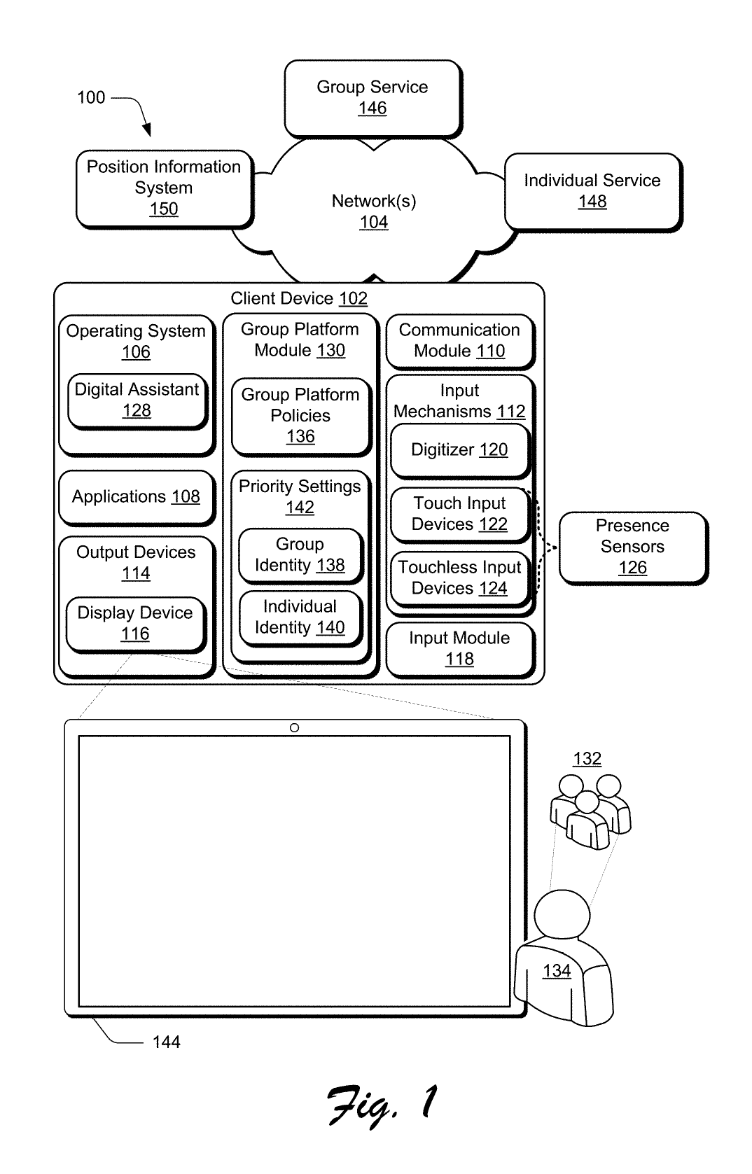

FIG. 1 is an illustration of an environment 100 in an example implementation that is operable to employ techniques for group interactions discussed herein. Generally, the environment 100 includes various devices, services, and networks that enable interaction via a variety of different modalities. For instance, the environment 100 includes a client device 102 connected to a network 104. The client device 102 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth. According to various implementations, the client device 102 may be configured for output without a screen, such as audio output, haptic output, and so forth.

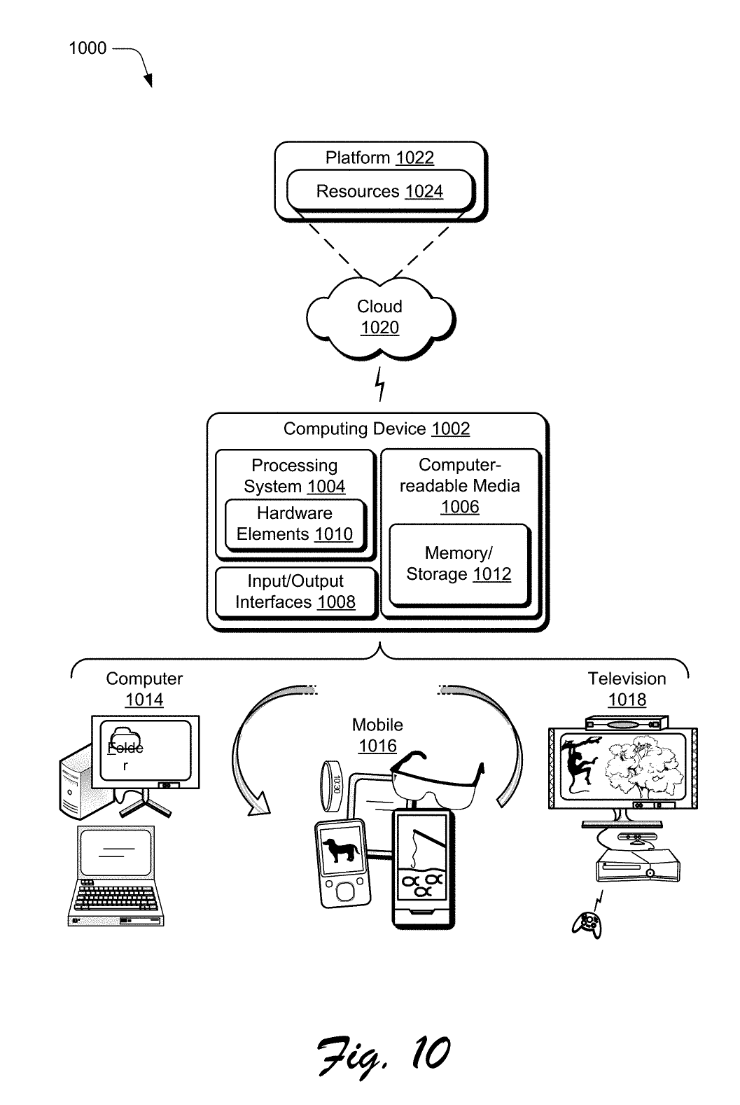

In at least some implementations, the client device 102 represents a smart appliance, such as an Internet of Things (“IoT”) device. Thus, the client device 102 may range from a system with significant processing power, to a lightweight device with minimal processing power. One of a variety of different examples of the client device 102 is shown and described below in FIG. 10.

The network 104 is representative of a network that provides the client device 102 with connectivity to various networks and/or services, such as the Internet. The network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 104 represents different interconnected wired and wireless networks.

The client device 102 includes a variety of different functionalities that enable various activities and tasks to be performed. For instance, the client device 102 includes an operating system 106, applications 108, and a communication module 110. Generally, the operating system 106 is representative of functionality for abstracting various system components of the client device 102, such as hardware, kernel-level modules and services, and so forth. The operating system 106, for instance, can abstract various components of the client device 102 to the applications 108 to enable interaction between the components and the applications 108.

The applications 108 represent functionalities for performing different tasks via the client device 102. Examples of the applications 108 include a word processing application, a spreadsheet application, a web browser, a gaming application, a media player, and so forth. The applications 108 may be installed locally on the client device 102 to be executed via a local runtime environment, and/or may represent portals to remote functionality, such as cloud-based services, web apps, and so forth. Thus, the applications 108 may take a variety of forms, such as locally-executed code, portals to remotely hosted services, and so forth.

The communication module 110 is representative of functionality for enabling the client device 102 to communicate data over wired and/or wireless connections. For instance, the communication module 110 represents hardware and logic for data communication via a variety of different wired and/or wireless technologies and protocols.

The client device 102 further includes various functionalities for input and output, including input mechanisms 112, a output devices 114, and an input module 118. The input mechanisms 112 generally represent different functionalities for receiving input to the client device 102, and the input module 118 is representative of functionality to enable the client device 102 to receive input data from the input mechanisms 112 and to process and route the input data in various ways.

The output devices 114 generally represent different functionalities for output from the client device 102. Examples of the output devices 114 include a display device 116 (e.g., a monitor or projector), speakers, a printer, a tactile-response device, and so forth. The display device 116 represents functionality for visual output for the client device 102. Additionally, the display device 116 represents functionality for receiving various types of input, such as touch input, pen input, and so forth. The display device 116, for example, represents an instance of the input mechanisms 112.

The input mechanisms include a digitizer 120, touch input devices 122, and touchless input devices 124. Examples of the input mechanisms 112 include gesture-sensitive sensors and devices (e.g., such as touch-based sensors and movement-tracking sensors (e.g., camera-based)), a mouse, a keyboard, a stylus, a touch pad, accelerometers, a microphone with accompanying voice recognition software, and so forth. The input mechanisms 112 may be separate or integral with the output devices 114 (e.g., the display device 116); integral examples include gesture-sensitive displays with integrated touch-sensitive or motion-sensitive sensors. The digitizer 120 represents functionality for converting various types of input to the touch input devices 122, the touchless input devices 124, and/or the display device 116 into digital data that can be used by the client device 102 in various ways.

The touch input devices 122 generally represent different devices for recognizing touch input, and are configured to receive touch input in a variety of ways. For example, the touch input devices 122 may include capacitive sensors, gesture-sensitive touch sensors, or other sensors configured to detect physical touch.

The touchless input devices 124 generally represent different devices for recognizing different types of non-contact input, and are configured to receive a variety of touchless input, such as via visual recognition of human gestures, object scanning, voice recognition, color recognition, and so on. For instance, the touchless input devices 124 include light sensors, audio sensors, and/or any combination thereof. Generally, these different sensors may individually and/or in combination sense various phenomena such as user presence, user distance, user identity recognition, biometric attributes, sound (e.g., user speech and other sounds), along with other user and/or environmental attributes. While not expressly illustrated, other types of touchless input devices 124 may be employed, such as to detect orientation, acceleration, rotation, electromagnetic radiation (e.g., radio waves, microwaves, infrared), capacitance, and so forth.

According to various implementations, different instances and combinations of the touch input devices 122 and the touchless input devices 124 can be implemented as presence sensors 126. Generally, the presence sensors 126 may sense various phenomena such as user presence, user distance, user identity recognition, biometric attributes, sound (e.g., user speech and other sounds), light (e.g., environmental lighting changes), along with other user and/or environmental attributes. The presence sensors 126 may alternatively or additionally detect other types of contextual information, such as user identity, time of day, user preferences, and so forth.

The presence sensors 126 may detect the physical presence of people (i.e., nearby the client device 102) using sensors like pyro-electric infrared sensors, passive infrared (PIR) sensors, microwave radar, microphones or cameras, and using techniques in accordance with the input module 118 such as Doppler radar, radar using time-of-flight sensing, angle-of-arrival sensing inferred from one of the above techniques, and so forth. While the inferences from PIR sensors are mostly binary, modalities like radar can provide more fine-grained information, that can include a positioning element (e.g., x/y/z position relative to the PC), an element indicative of distance to the person (e.g., magnitude of the returned signal), or an element that allows for inferences of certain situations like approaching the system. Another technique to recognize presence involves using position of a user's other devices, such as detecting that a user's smartphone or tablet device is connected within a network.

In order to enable voice interaction functionality, one or multiple microphones can be employed. Using multiple microphones enables the use of sophisticated beamforming techniques to raise the quality of speech recognition and thus the overall interaction experience. Also, the system can disambiguate between multiple sound sources (e.g., by filtering out the position of a known TV or background noise). When the identity of a user is known, it is possible to apply a different speech recognition model that actually fits the user's accent, language, acoustic speech frequencies, and demographics (e.g., age).

As noted above, radar or camera-based sensors may provide a position for one or multiple users. The position is then used by the input module 118 to infer context. For example, whether a person just passes by or has the intention to actually interact. Distance and/or proximity can also be detected using ultrasonic, time-of-flight, radar, and/or other techniques.

The input module 118 may perform identity recognition by employing camera-based face recognition or more coarse-grained recognition techniques that approximate the identity of a user (e.g., when she or he is further away). The system may also recognize the locations or movements of other devices which may be personal devices, and the input module 118 may use this to determine identity. This may be done with or without cooperating software components on those devices. For example, accelerometer events detected by a smartphone may be correlated with movements sensed for a particular user, allowing the system to infer that, with some probability, the moving user's identity is that of the smartphone owner. In another example, the radio signals (e.g., WiFi® signals, Bluetooth® signals, and so forth) from a smartphone may be localized and this location may be correlated to a user to (probabilistically) identify the user.

Similar to the previously discussed camera-based identity recognition, estimating an emotional state is another factor that may be employed. The emotional state can be derived based on the presence sensors 126 to infer a situation in which an emotional state of a user that can be used to adapt the system behavior even further. Thermographic imaging, biometric sensor data, and voice analysis can also be used to infer emotional state.

The presence sensors 126 may be included with the client device 102 and/or available from other connected devices, such as sensors associated with multiple computers in a home network, sensors on a user's phone, sensors integrated in a display device, and so forth. A presence sensor 126 and/or set of the presence sensors 126, for instance, can be implemented as a dedicated sensor subsystem with a dedicated processor, storage, power supply, and so forth, that can detect various phenomena and communicate signals to the client device 102, such as a binary signal to wake the client device 102 from a sleep or off mode. The presence sensors 126, for instance, can actively detect various phenomena and contextual information while the client device 102 is in a sleep mode. In at least some implementations, the client device 102 may communicate with and obtain sensor data from connected devices over the network 104 and/or via a local or cloud service.

The client device 102 may include or make use of a digital assistant 128. In the illustrated example, the digital assistant 128 is depicted as being integrated with the operating system 106. The digital assistant 128 may additionally or alternatively be implemented as a stand-alone application, a component of a different application, as a network-based service (e.g., a cloud-based service), and so forth.

Generally, the digital assistant 128 is representative of functionality to utilize natural language processing, a knowledge database, and artificial intelligence implemented by the system to interpret and perform requested tasks, provide requested advice and information, and/or invoke various services to complete requested actions. For example, requests received by the digital assistant 128 may include spoken or written (e.g., typed text) data that is received through the input module 118 via the presence sensors 126 and interpreted through natural language processing capabilities of the digital assistant 128. The digital assistant 128 may also receive environmental context (e.g., as detected by the input mechanisms 112), and use the environment context to provide feedback and/or relevant functionality to a user. The digital assistant 128 may interpret various input and contextual clues to infer an intent, translate the inferred intent into actionable tasks and parameters, and then execute operations and deploy services to perform the tasks. Thus, the digital assistant 128 is designed to act on behalf of a user to produce outputs that attempt to fulfill the user's intent as expressed during natural language interactions between the user and the digital assistant.

The client device 102 further includes a group platform module 130, which is representative of functionality to perform various tasks pertaining to techniques for group interactions discussed herein. The group platform module 130, for instance, can be leveraged to manage interactions for a group 132 and a user 134. For example, the group platform module 130 performs content aggregation and/or presentation for the group 132 and the user 134. Various attributes and operational aspects of the group platform module 130 are detailed below. In implementations, the group platform module 130 can manage, control, and/or interact with the operating system 106 of the client device 102 to enable the group interaction techniques described herein. As described herein, “a group” can refer to one or more individuals. In some instances, a group is representative of a family, a group of friends, roommates, co-workers, a caregiver, a guest, and so on. As such, the term “group” as used herein generally represents one or more individuals referred to collectively.

The group platform module 130 maintains group platform policies 136, which are representative of different sets of data that specify permissions and criteria for aggregating and/or presenting content for the group 132. The group platform policies 136, for instance, specify which content to present and how to configure content for display based on factors associated with priority, identity, presence of individuals, and so forth. As further discussed below, data utilized by the group platform module 130 may be obtained from a cloud-based service that manages and propagates information pertaining to identity, priority, and so forth. In some implementations, the group platform policies 136 are content and/or application-specific. For example, the group platform policies 136 can specify certain types of content that are permitted to be presented to each member of the group 132, and other types of content that are not permitted to be presented to each member of the group 132. Generally, the group platform policies 136 can be configured in various ways such as via default settings, settings specified by an end user, by information technology (IT) personnel, and so forth.

The group platform module 130 may include or make use of a group identity 138 and an individual identity 140. Generally, the group identity 138 corresponds to a device ticket, user ticket, a credential, or other qualification that is suitable for representing the group 132, enabling each individual in the group 132 to interact with a computing device using the group identity 138.

Each individual in the group 132 can be represented by a unique individual identity 140 which may be used to identify and authenticate the individual. Generally, the individual identity 140 corresponds to a device ticket, user ticket, a credential, or other qualification that is suitable for representing an individual user, such as the user 134.

According to various implementations, the group platform module 130 can create and/or modify the group platform policies 136 related to the group identity 138 such as settings for an account profile, email accounts for the group 132 and/or email accounts for users associated with the group 132, Virtual Private Network (VPN) access, sign-in options (e.g., use of biometrics and other specific sensors for identifying a user), device location tracking settings, privacy settings, recovery settings, back-up settings, and so on. Further, privacy settings provided by the group platform policies 136 can include settings related to account information, application information, messaging, and/or email, just to name a few. Privacy settings can be provided by default by the group platform module 130 or the operating system 106, for instance, or may be provided by a user from the group 132. Settings can also be provided by the group platform policies 136 to specify access for a guest to content associated with the group identity 138. In some implementations, a caregiver, relative, and/or friend can be added to the group identity 138 to provide interactions with the group 132 associated with the group identity 138. According to various implementations, the group platform policies 136 may also specify public access to content associated with the group identity 138 to anyone with access to the client device 102.

According to various implementations, the group platform module 130 can enable each individual associated with the group 132 to interact with the client device 102 using the same group identity 138. For instance, the group platform module 130 can use the group identity 138 to automatically authorize interactions for each group member, typically after one group member initiates creating the group 132. In one specific example, the group platform module 130 can automatically authorize access for each individual associated with the group identity 138 to functionality provided by the group platform module 130. In this way, each individual of the group 132 can automatically interact with the functionality provided by the group platform module 130 independent of being required to explicitly provide an input. In some implementations, access requires explicit input according to the group platform policies 136. For instance, the group platform policies specify that when a guest is detected by the presence sensors 126, the functionality provided by the group platform module 130 is not presented without explicit input.

The group platform module 130 further maintains priority settings 142, which are representative of different sets of data that specify priority for each individual user from the group 132 relative to each other. The priority settings 142 may be determined by the group platform module 130 for each user from the group 132 and may be based on the group identity 138 and the respective individual identity 140 of each user. In various implementations, the priority settings 142 may be content and/or application-specific and may be used by the group platform module 130 to resolve conflicts regarding presentation of content. Generally, the priority settings 142 may be based on user-defined or default settings and may be assigned in a number of ways including assignment upon initial creation of the group identity 138, after the group identity 138 is created, as part of adding a new individual identity 140 to the group identity 138, and so forth. Further to techniques discussed herein, the priority settings 142 are determined and enforced in accordance with the group platform policies 136 and, as a result, modification of the group platform policies 136 may cause modification to the priority settings 142.

According to various implementations, the group platform module 130 may operate under the influence of sensor data collected via the presence sensors 126 to perform various tasks, such as to manage and adapt device modes, availability of the digital assistant 128, application states, and so forth. The adaptations implemented via the group platform module 130 include selectively invoking, waking, and suspending the digital assistant 128 in dependence upon indications obtained from the presence sensors 126 and/or the input module 118, such as user presence, identity, and/or proximity. The adaptations further include selective modification to a user experience (“UX”) based on sensor data and context.

In at least some implementations, the group platform module 130 can generate a desktop in which individuals from the group 132 can interact. As described herein, a “desktop” represents an interaction point for persons operating a computing device, such as the client device 102, in accordance with the group identity 138. A desktop, for instance, represents a functional collection of interaction affordances that can be configured in various ways according to techniques for group interactions described herein. Because a desktop generated by the group platform module 130 operates in the context of the group identity 138, the desktop can be thought of as a “communal desktop” or a “shared desktop.” Generally, a shared desktop generated by the group platform module 130 can be useful in settings where people congregate because it promotes sharing without the hindrances found in typical group interfaces.

The environment 100 further includes an example snapshot of a graphical user interface (“GUI”) 144 that can be output on the display device 116 by the group platform module 130 to employ group interaction techniques. By configuring the GUI 144 in the various ways described herein, the group platform module 130 can employ group interaction techniques that enable a group of individuals to organize, coordinate, share, and present information. According to various implementations, the GUI 144 can be implemented by the group platform module 130 as an application and/or a UX and can be made available to devices associated with the group identity 138 via the network 104. Regardless of where the GUI 144 is used, the GUI 144 is generally representative of a location to promote quick and easy interaction with displayed content.

The group platform module 130 may configure the GUI 144 for implementation with various adaptations including selectively invoking, waking, and suspending the GUI 144 in dependence upon indications obtained from the presence sensors 126, such as user presence, identity, and/or proximity. The adaptations further include selective modification to the UX based on sensor data and context. For example, different visualizations of the GUI 144 may be output for different interaction scenarios based on user presence. In some implementations, the GUI 144 may be dynamically adapted through the course of a particular action based on recognized changes to number of users present, proximity, availability of secondary device/display, lighting conditions, user activity, and so forth. Further, the GUI 144 may also be adapted based on accessibility considerations, such as to accommodate various disabilities. According to various implementations, the group platform module 130 configures the GUI 144 for implementation with various adaptations including selectively invoking, waking, and suspending the GUI 144 in dependence upon a time of day or learned behavior of the group 132 or an individual from the group 132.

As described above, the group platform module 130 obtains sensor data that may be collected via various presence sensors 126. The sensor data is analyzed and interpreted by the group platform module 130 to determine contextual factors such as user presence, identity, proximity, emotional state, and other factors noted above and below. Adaptations that correspond to a current context are thus identified and applied to adapt the GUI 144 accordingly.

In this environment, the user 134 represents a single user associated with the group 132, but it will be appreciated that more than one user may interact with the GUI 144 in this environment.

The environment 100 further includes a group service 146 and an individual service 148 which are accessible to the client device 102 over the network 104. Generally, the group service 146 is representative of a network-based functionality for providing account, profile, data, and services related to the group identity 138. In at least some implementations, the group identity 138, the individual identity 140, the group platform policies 136, and/or the priority settings 142 may be obtained from the group service 146.

Techniques for group data and priority in an individual desktop discussed herein may be performed by the group platform module 130, the group service 146, and/or via interaction between the group platform module 130 and the group service 146. In at least some implementations, the group service 146 hosts an instance of the group platform module 130 that is accessible to the client device 102 and other devices over the network 104, including other devices used by the user 134 from the group 132 or other individuals from the group 132.

The individual service 148 is representative of a network-based functionality for providing account, data, profile, and services related to the individual identity 140 associated with the user 134 from the group 132. For instance, providing account, profile, and services related to the individual identity 140 may be performed by the group platform module 130, the individual service 148, and/or via interaction between the group platform module 130 and the individual service 148. While the group service 146 and the individual service 148 are represented in FIG. 1 as separate elements, it should be appreciated that the functionality of both the group service 146 and the individual service 148 may be performed by a single identity service, the group platform module 130, and/or interactions between an identity service and the group platform module 130.

The environment 100 further includes a position information system 150 which is accessible to the client device 102 over the network 104. The position information system 150 is representative of various types of position information systems that can transmit and/or receive position information. Examples of the position information system 150 include Global Positioning System (“GPS”) satellites, cellular telephone networks, wireless data (e.g., WiFi™) networks, location information services (LIS), radio frequency identifier (RFID) functionality, subnets of wired networks, Ethernet switches and/or ports, and so forth.

In at least some implementations, the position information system 150 includes various data network components, such as wired and/or wireless data (e.g., Ethernet) switches, ports, routers, and so forth. According to various implementations, position information can be communicated between the group platform module 130 and the position information system 150 to enable a location of the client device 102 or a device associated with the group identity 138 to be determined. Examples of position information include GPS coordinates, street addresses, network location, location with reference to cell towers and/or cellular base stations, and so forth.

Having described an example environment in which the techniques described herein may operate, consider now a discussion of some example implementation scenarios in accordance with one or more embodiments.

Example Implementation Scenarios

The following section describes example implementation scenarios for group interactions in accordance with one or more implementations. The implementation scenarios may be implemented in the environment 100 discussed above, the system of FIG. 10, and/or any other suitable environment.

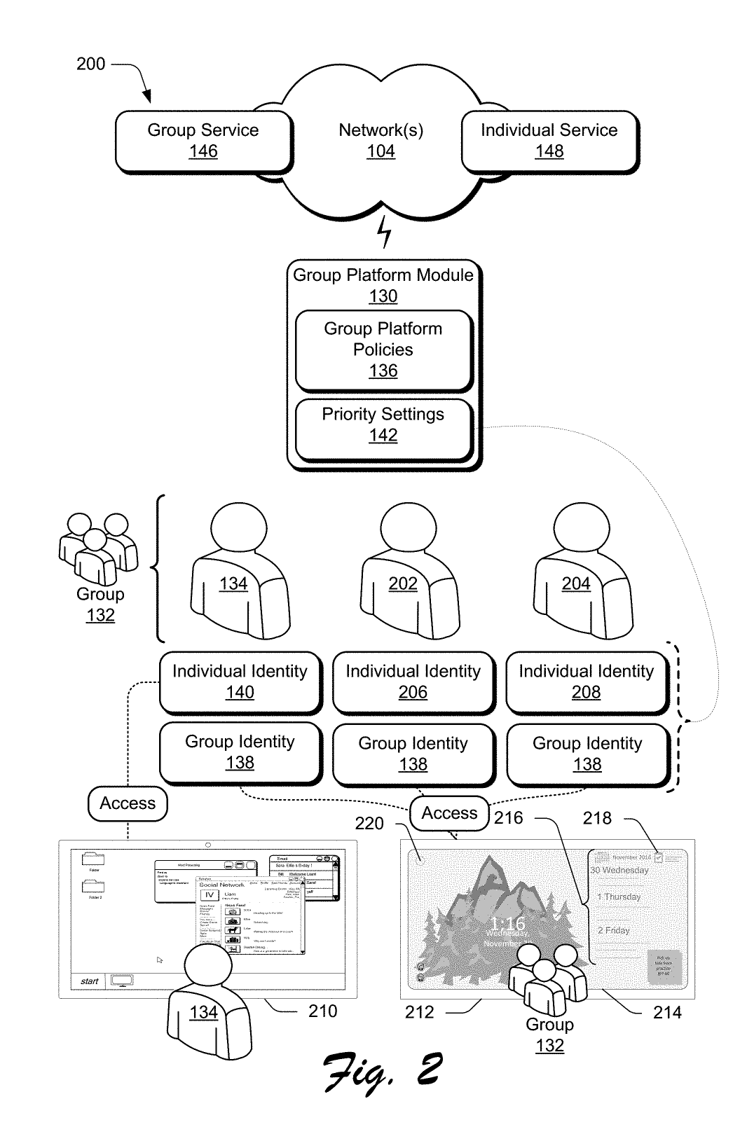

FIG. 2 depicts an example implementation scenario 200 for configuring a group identity with individual identities and priority settings in accordance with one or more implementations. The scenario 200 includes various entities and components introduced above with reference to the environment 100.

The scenario 200 includes the group 132 representative of a group of individual users, the user 134 (an adult, “Alice”), adult user 202 (“Bob”), and child user 204 (“Cathy”), all associated with the group 132. The individual identity 140 of one of the users from the group 132 is validated. Validation may be performed locally (e.g., by the operating system 106 of FIG. 1 or the group platform module 130) or over the network 104 by the individual service 148 or group service 146.

In this particular scenario, the group platform module 130 validates the individual identity 140 associated with Alice. Validation of the individual identity 140 and/or the group identity 138 may be performed in a number of ways, such via attributes of Alice detected via the presence sensors 126, input of Alice's credentials (e.g., username and password), and so forth. Input received via the presence sensors 126 of FIG. 1, for instance, is validated by the operating system 106 of FIG. 1 or the group platform module 130. Validation of the individual identity 140 may be provided by the individual service 148 over the network 104, or by other means as described above.

In this instance, the individual service provides account, profile, and services related to the individual identities 140, 206, 208 corresponding to Alice, Bob, and Cathy, respectively. Alternatively or additionally, the individual identities 140, 206, 208 may be authorized by the group service 146. In at least one implementation, the operating system 106 from FIG. 1 may be configured to run as the individual identity 140, 206, or 208 for Alice, Bob, or Cathy respectively.

Further to this scenario, and responsive to validating the individual identity 140 for the user 134 (“Alice”), an individual desktop 210 is presented to Alice. The individual desktop 210 may be executed on the client device 102 of FIG. 1 or, alternatively, on a different computing device entirely. Generally, the individual desktop 210 represents functionality to present a desktop to an individual after the individual's identity has been verified, such as via presence sensing that verifies the presence and identity of an individual, by an individual entering a username and password, and so forth. The individual desktop 210, for instance, is configured to provide functionality of an operating system in an individual context. For example, the individual desktop 210 can integrate data associated with the individual identity 140 to provide applications and/or services in accordance with the individual context. Note that in the scenario 200, Alice has access to the individual desktop 210 through the individual identity 140 while Bob and Cathy do not have access to the individual desktop 210 through their respective individual identities 206, 208. The individual identities 206, 208 for Bob and Cathy, for example, do not entitle Bob and Cathy to access to the individual desktop 210, but do allow them access to a shared desktop 212 associated with the group identity 138.

In the scenario 200, the group platform module 130 authorizes the group identity 138 for Alice, Bob, and Cathy, associated with the group 132. In some implementations, the group identity 138 may be authorized from the group service 146 over the network 104. Further, the group platform module 130 can configure the group identity 138 as a device ticket that communicates to other applications and/or services security information related to the group 132. The group identity 138, for example, represents multiple users as a collective whole i.e., a single entity.

The group identity 138 may be created in several ways including, for example, during an “out-of-the-box experience” upon initial setup of a shared computing device (e.g., the client device 102) and/or at any point in time subsequent to initial setup. For instance, Alice sets up the group identity 138 on the shared device for each individual identity 140, 206, 208 to use in a group context. A shared computing device (which may be the client device 102), for instance, includes the group platform module 130 configured to generate the group identity 138 by verifying each individual user's identity. In some implementations, the group identity 138 is created from a device other than the shared computing device, including but not limited to the client device 102. In some implementations, the group identity 138 is created in response to an offer to set up the group identity 138 based on contextual information (e.g., user behaviors) indicating that an individual is engaging in group interactions. For instance, the individual identities 140, 206, 208 are used on the client device 102 and as a result, the group platform module 130 instructs the operating system 106 to offer to set up the group identity 138 for Alice.

According to various implementations, the group platform module 130 creates the group identity 138 for each user associated with the group 132 and assigns the group identity 138 automatically to each user associated with the group 132. For instance, the group platform module 130 automatically associates the group identity 138 with the individual identities 140, 206, 208 associated with Alice, Bob, and Cathy, respectively. In at least some implementations, the group platform module 130 may associate the group identity 138 with each user associated with the group 132 even if each user is not associated with the shared computing device, and/or across multiple platforms, networks, or applications.

Generally, the group platform module 130 forms, collects, exchanges, and/or aggregates content related to the group identity 138 and the individual identities 140, 206, 208. In various implementations, the group platform module 130 causes content obtained (e.g., purchased) by an individual user from the group 132 to be stored in association with the group identity 138. As an example, Alice purchases a song from a third-party music service through the individual identity 140. Subsequently, the purchased song is made available to Bob and Cathy through the group identity 138's association with Alice's individual identity 140 through which the song was purchased. Whether or not content obtained by an individual is associated with the group identity 138 may depend on application-specific or service-specific settings and licenses. Additionally, availability of content obtained by an individual to the group identity is determined in accordance with the group platform policies 136.

In some instances, individuals of the group 132 control their individual data by “pushing” their respective data to the shared desktop 212. Thus, in some implementations, the group platform module 130 can be configured to let individuals control their privacy, e.g., personal data. In this way, the group platform module 130 can form the shared desktop 212 to include sub-sets of individual data which do not include sensitive individual data that a particular individual would rather not include in the group context.

In further implementations, the group platform module 130 enables one or more users from group 132 to communicate and/or exchange data through first or third-party applications or services using the group identity 138. Additionally, the group platform module 130 may identify first or third-party applications, services, or data associated with an individual identity of a user from the group 132 and cause conversion in whole or in part of the application, services, or data to a group context in association with the group identity 138.

Generally, the group platform module 130 configures the group identity 138 for use in various ways that enable each associated user to efficiently bypass conventional barriers to interacting with content associated with the group identity 138. For example, the group platform module 130 can configure the group identity 138 as a device ticket that communicates security information related to the group 132 to other applications and/or services. Thus, in this scenario, Alice, Bob and Cathy may access “group-aware” content through the shared desktop 212 without further associating the group-aware content with their respective individual identities 140, 206, 208.

Accordingly, the group platform module 130 provides the shared desktop 212 through the group identity 138 for Alice, Bob, and Cathy, in order to provide the group 132 with an interface for group interactions. Generally, the shared desktop 212 can integrate data from various sources to provide applications and/or services in accordance with the group context. According to various implementations, the group platform module 130 provides the shared desktop 212 via interaction with the operating system 106. For instance, the shared desktop 212 can be generated by the group platform module 130 to incorporate a system shell that provides a desktop having a group context. In some implementations, the shared desktop 212 can be configured to represent a “welcome screen” 214 that provides functionality to support sharing of information among one or more different individuals of the group 132.

In this scenario, the shared desktop 212 is configured as the welcome screen 214, depicting a group calendar 216, notes and reminders 218, and voice service 220. According to various implementations, the voice service 220 may be implemented as the digital assistant 128 of FIG. 1 and may support interaction with the group calendar 216 and any other content presented in or available for interaction through the shared desktop 212 to provide simple and immediate input capabilities to the users 134, 202, 204.

Generally, the shared desktop 212 can enable presentation of various kinds of information associated with the group identity 138 or the individual identities 140, 206, 208 including but not limited to: schedules, reminders, lists, notifications, media (e.g., photos, video, music, and so on), weather, and settings. In some implementations, the shared desktop 212 can appear on the display device 116 responsive to creation of the group identity 138 by the group platform module 130 and/or can act as a default location for individuals accessing the shared desktop 212.

In at least some implementations, Alice, Bob, and Cathy may have different priority settings 142 determined based on the group identity 138 and the individual identities 140, 206, 208. For instance, Alice and Bob (as adult users) and Cathy (as a child user) have different priority settings 142 for interacting with content associated with the group identity 138, in accordance with the group platform policies 136. In at least one implementation, the priority settings 142 are assigned upon initial creation of the group identity 138 and/or as a subsequent configuration event. As one example, upon initial setup of the group identity 138, the users associated with the group 132, Alice, Bob, and Cathy, may be identified by age or age classification (i.e., adult and child) by Alice while performing the initial setup. As a result, different priority settings 142 and group platform policies 136 will be determined for Cathy, relative to Alice and Bob, due to Cathy's age and/or age classification, e.g., child, in this example.

Thus, the group platform module 130 causes content presented to be group-aware by modifying the content for output in accordance with the group identity 138 and the priority settings 142. As detailed below, the modifying can include altering, replacing, updating, including, excluding, and/or exchanging data for presentation to meet the collective needs of each user from the group 132.

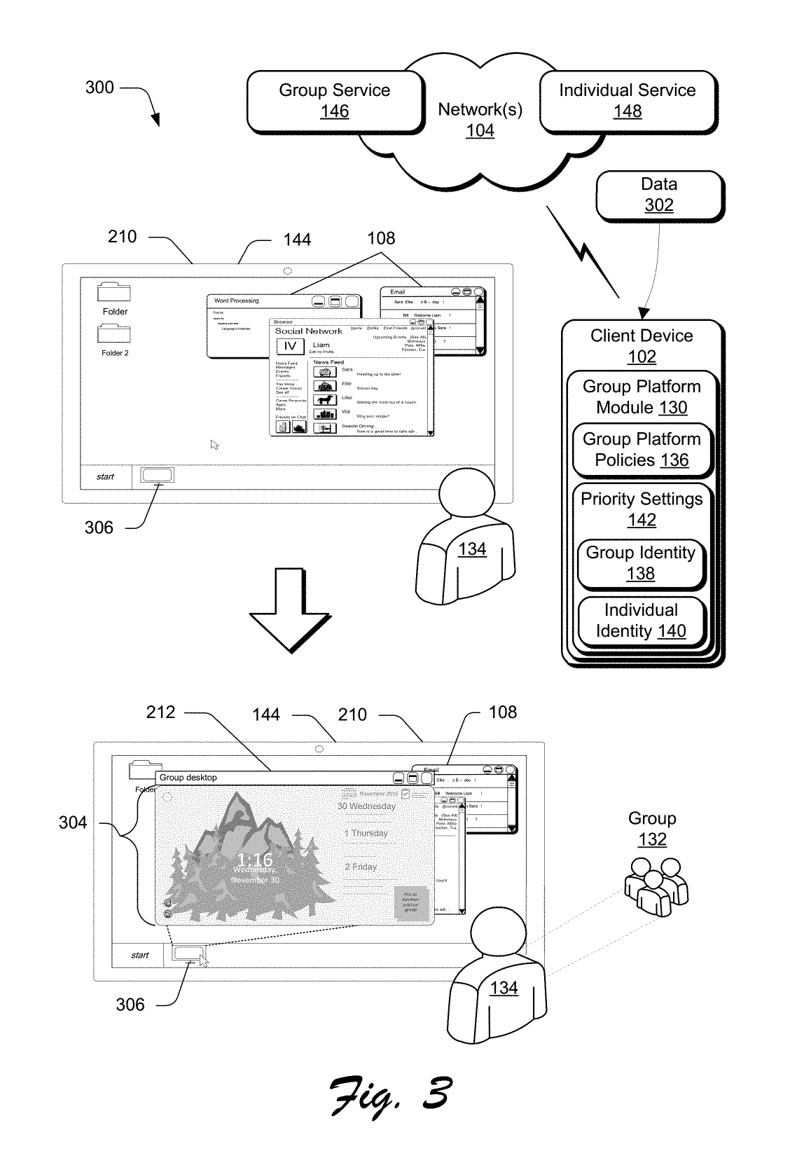

FIG. 3 depicts an example implementation scenario 300 for presenting a shared desktop experience in an individual desktop in accordance with one or more implementations. The scenario 300 includes various entities and components introduced above with reference to the environment 100, and may be implemented in conjunction with the scenario 200.

The scenario 300 includes the user 134 (“Alice”) from the group 132 and the client device 102 having the group platform module 130. In this particular scenario, the group platform module 130 identifies the individual identity 140 associated with the user 134, such as via presence detection by the presence sensors 126, direct user input by the user 134, and so forth. Validation of the individual identity 140 may be performed in other ways, examples of which are discussed above. Accordingly, the group platform module 130 identifies and validates the individual identity 140 associated with the user 134, Alice. In one implementation, the individual identity 140 was initially assigned by the operating system 106, for instance, as part of configuration of the client device 102.

As shown, the GUI 144 is presented on the display device 116 of the client device 102 for viewing by the user 134 to enable interaction with the individual desktop 210. In this instance, the user 134 represents a single user associated with the group 132. In some implementations, the GUI 144 can be output on a display of a device(s) other than the client device 102, such as a display of a device associated with a different user of the group identity 138 other than the user 134. In this instance, aspects of the individual desktop 210 are output via the GUI 144 on the display device 116, but it will be appreciated that any of the output devices 114 are contemplated to enable the functionality of the individual desktop 210. For instance, the output devices 114 can provide other types of output for the desktop 210 alternatively or additionally to visual output, such as audio output, haptic output, and so forth.

As depicted in the scenario 300, the individual desktop 210 displays applications 108 associated with the individual identity 140. Generally, the applications 108 represent functionalities for performing different tasks via the individual desktop 210. Examples of the applications 108 include a word processing application, a spreadsheet application, a web browser, a gaming application, a media player, and so forth. The applications 108 may be installed locally to be executed via a local runtime environment, and/or may represent portals to remote functionality, such as cloud-based services, web apps, and so forth.

After the individual identity 140 is validated, the user 134 has access to the functionality of the individual desktop 210 including the applications 108. Further, the individual identity 140 is associated with the group identity 138. Accordingly, the group platform module 130 identifies and/or aggregates data 302 associated with the group identity 138. In this instance, the group platform module 130 is implemented on the client device 102. However, the group platform module 130 may additionally or alternatively be implemented on a different device locally or over the network 104, such as via the group service 146. According to various implementations, the data 302 may consist of data associated with the group identity 138 and/or the individual identities 140, 206, 208 from the group 132. The data 302 may include shared data, such as calendar information, notes, documents, content, and so forth. The data 302 may also include data specific to an application or a service. In this instance, the data 302 aggregated by the group platform module 130 is shared data, such as that presented on the welcome screen 214 in the shared desktop 212, e.g., data related to the group calendar 216, the notes and reminders 218, and so forth.

Further to the scenario 300, the group platform module 130 applies the priority settings 142 to the data 302 to determine group data 304 for presentation to the user 134. The group platform module 130, for instance, optimizes the data 302 to generate the group data 304 based on the individual identity 140 of the user 134 as applied to the priority settings 142 in accordance with the group platform policies 136. For instance, the group platform module 130 determines that the shared desktop 212 configured as the welcome screen 214 includes data associated with both the group identity 138 and Alice's individual identity 140. Thus, the group platform module 130 prioritizes data associated with both the group identity 138 and Alice's individual identity 140 over data associated with both the group identity 138 and a different individual identity, such as Bob or Cathy's individual identities 206, 208.

The scenario 300 further depicts the individual desktop 210 including an interactive portion 306 usable to employ the shared desktop 212 in a session associated with the individual identity 140. In this particular implementation, the interactive portion 306 is located in the lower left portion of both individual desktops 210 depicted. The interactive portion 306 represents functionality to access or launch the shared desktop 212 via an interaction, e.g., through the input mechanisms 112.

According to various implementations, the interactive portion 306 is selectable to cause presentation of the group data 304 associated with the group identity 138 and/or the individual identities 140, 206, and 208. In this scenario, the interactive portion 306 is selected by the user 134, such as via one of the input mechanisms 112. As a result, an instance of the shared desktop 212 is presented within the individual desktop 210 on the GUI 144, as shown in the lower portion of the scenario 300. Thus, the group platform module 130 presents group data 304 associated with the group identity 138 and the individual identity 140 on the GUI 144 through an instance of the shared desktop 212, thereby enabling the user 134 to interact with the group data 304 through the individual desktop 210.

In implementations, the group platform module 130 enables an instance of the individual desktop 210 to run on a first computing device and an instance of the shared desktop 212 to run on a second computing device. Different examples of the first and second computing devices are discussed in relation to the computing device(s) of FIGS. 1 and 10.

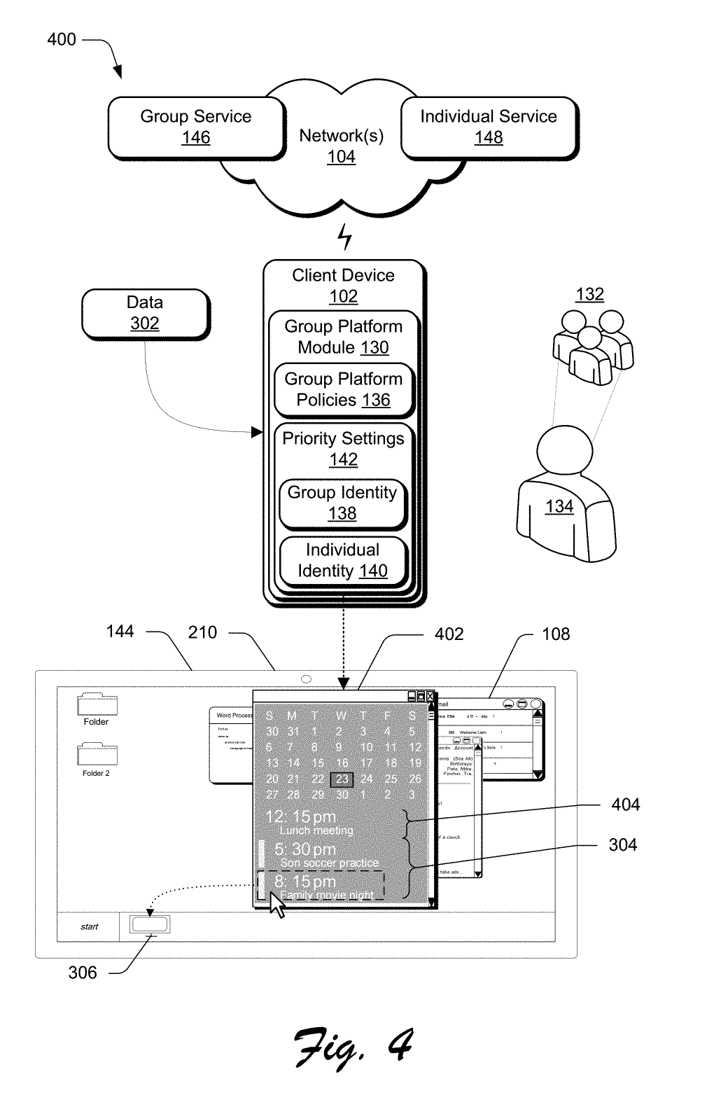

FIG. 4 depicts an example implementation scenario 400 for integrating group data in an individual desktop in accordance with one or more implementations. The scenario 400 includes various entities and components introduced above with reference to the environment 100, and may be implemented in conjunction with the scenarios 200, 300.

The scenario includes the user 134 (“Alice”) from the group 132 and the client device 102 having the group platform module 130. In this particular scenario, the group platform module 130 identifies and validates the individual identity 140 associated with Alice, such as through the individual service 148 and/or the group service 146. Different ways of identifying and validating the individual identity 140 are described above.

As shown, the GUI 144 is presented on the client device 102 (e.g., on the display device 116) to Alice for interacting with the individual desktop 210. The individual desktop 210 includes the applications 108 associated with the individual identity 140 and the interactive portion 306 usable to employ the shared desktop 212 in a session associated with the individual identity 140. In this scenario, a calendar application 402 is presented on the individual desktop 210. While the calendar application 402 is depicted in this scenario, it should be understood that any application or service associated with the individual identity 140 may be utilized.

In the scenario 400, Alice's individual identity 140 is associated with the group identity 138. Accordingly, the group identity 138 is validated for the user 134 via the group service 146. Continuing with the scenario, the group platform module 130 identifies and/or aggregates data 302 associated with the group identity 138. The data 302 may consist of data associated with the group identity 138 and/or the individual identities 140, 206, 208 from the group 132. The data 302 may include shared data, such as calendar information, notes, content, and so forth. The data 302 may also include data specific to an application or a service. In this instance, the data 302 aggregated by the group platform module is calendar data, such as that presented on a welcome screen in the shared desktop 212. As an example, consider that the data 302 aggregated by the group platform module 130 includes both a calendar appointment associated with Alice's individual identity 140 (in this case, group data 304) and a calendar appointment associated with the group identity 138.

Further to the scenario 400, the group platform module 130 applies the priority settings 142 to the data 302 to determine the group data 304 for presentation to Alice. The group data 304 represents data 302 presented by the group platform module 130 based on the priority settings 142. The group platform module determines the priority settings 142 based on the individual identities 140, 206, 208 from the group 132, as well as the group identity 138. Thus, in this example, the priority settings 142 indicate that group data 304 associated with Alice's individual identity 140 has priority over group data 304 not directly associated with Alice's individual identity 140. For example, since Alice is present, Alice's individual identity 140 has a highest priority. As a result, the calendar appointment associated with Alice's individual identity 140, in this scenario group data 304, is presented on the calendar application 402 while group data 304 for a calendar appointment associated with Bob's individual identity 206 is not presented in the calendar application 402.

Continuing with this scenario, the group platform module 130 integrates the group data 304 with the individual data 404 for presentation in the individual desktop 210. In this instance, both the group data 304 and the individual data 404 are presented in the calendar application 402 of the individual desktop 210. Integrating group data 304 with individual data 404 provides the user 134 with access to all priority content in a single location.

The scenario 400 further depicts the individual desktop 210 including an interactive portion 306. In some implementations, the individual data 404 may be shared to the group identity 138 through the interactive portion 306. In this scenario, individual data 404 (the calendar appointment in the dashed box) is dragged to the interactive portion 306 on the individual desktop 210 to be shared on an instance of the shared desktop 212 (e.g., as described in the scenarios 200 or 300) and to the group identity 138. While a “click-and-drag” action is depicted here, it should be understood that any input means may be used to accomplish the described sharing. In this way, the group platform module 130 enables sharing the individual data 404 in a group interface (e.g., the shared desktop 212) with minimal barriers to doing so.

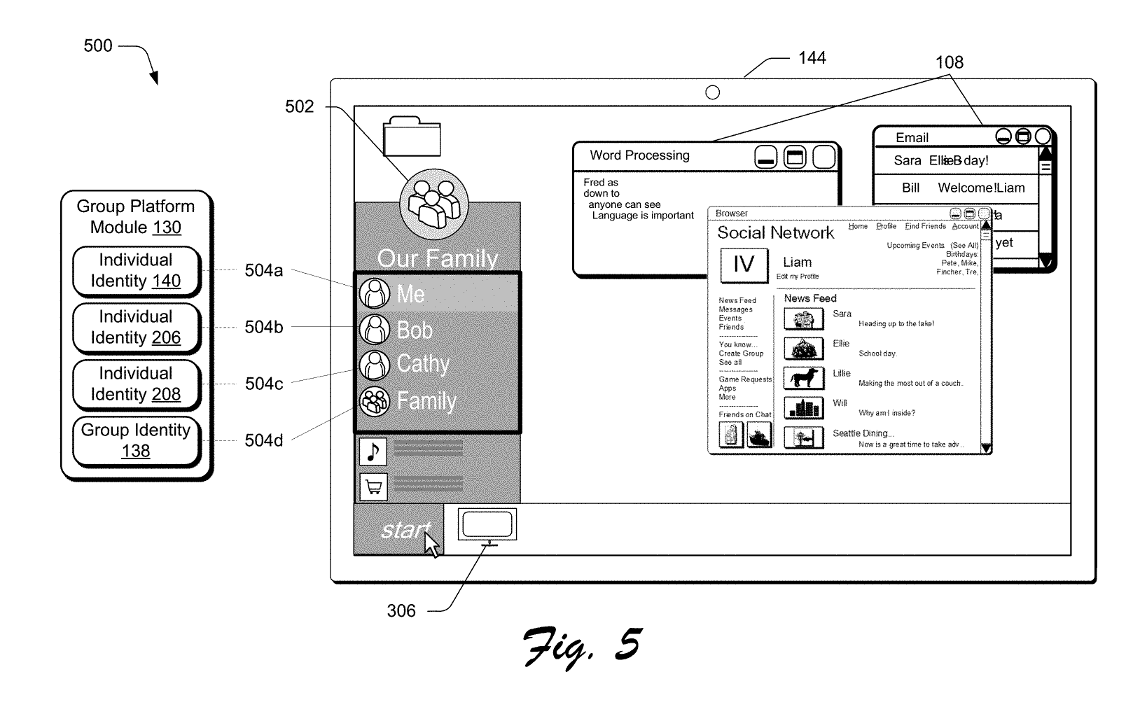

FIG. 5 depicts an example implementation scenario 500 for an identity switching control for groups in accordance with one or more implementations. The scenario 500 includes various entities and components introduced above with reference to the environment 100. The scenario 500, for instance, may be implemented in conjunction with the scenarios 200-400 described above.

In this particular scenario, the group platform module 130 identifies that the system is running as the individual identity 140 associated with the user 134. Accordingly, the GUI 144 is presented on the client device 102 (e.g., on the display device 116) to the user 134 and includes the individual desktop 210 associated with the individual identity 140. The individual desktop 210 includes the applications 108 associated with the individual identity 140 and the interactive portion 306 usable to employ the shared desktop 212 in a session associated with the individual identity 140.

Here, the individual identity 140 is associated with the group 132 and the group identity 138. Further, the individual desktop 210 includes an identity switching control 502 enabling switching among the individual desktop 210, the shared desktop 212, and other individual desktops associated with the group identity 138. The identity switching control 502 depicts the identities associated with the group 132 as a selectable visual representation 504a, a selectable visual representation 504b, and a selectable visual representation 504c that each represent a respective identity of the individual identities 140, 206, 208, respectively. In this example, individual desktops other than the individual desktop 210 are associated with the individual identities 206, 208. The identity switching control 502 further depicts the selectable visual representation 504d representing the group identity 138. While the identity switching control 502 is depicted here as a menu selector, it should be understood that various switching functionalities are contemplated to achieve the functionality of the identity switching control 502. For example, the identity switching control 502 may be configured as a stand-alone application or service, a function of the operating system 106, a toggle switch, a scrollable list, and so forth.

Selection of one of the visual representations 504a-504d presented in the identity switching control 502 causes the group platform module 130 to present the selected desktop instead of or in addition to the individual desktop 210. For instance, if a visual representation 504b associated with the individual identity 206 of Bob is selected, Bob's individual desktop would be presented in the GUI 144. Bob's individual desktop, for example, would be presented instead of Alice's individual desktop 210 or alternatively as a window within Alice's individual desktop 210, such as depicted by the shared desktop 212 within the individual desktop 210 in the scenario 300. Thus, the group platform module 130 allows switching between multiple identities on one device for group interactions.

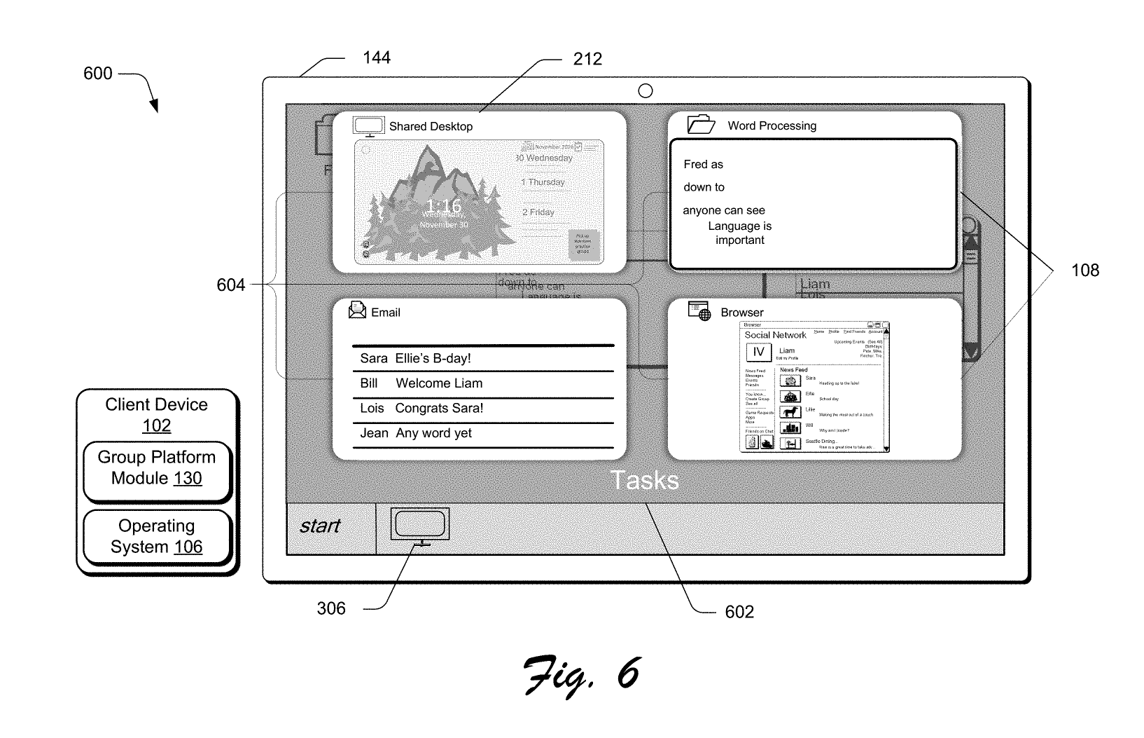

FIG. 6 depicts an example implementation scenario 600 for a task-switching control for groups in accordance with one or more implementations. The scenario 600 includes various entities and components introduced above with reference to the environment 100. The scenario 600, for instance, may be implemented in conjunction with the scenarios 200-500 described above.

In the scenario 600, the group platform module 130 identifies and validates the individual identity 140 associated with the user 134 through the individual service 148 over the network 104. Example ways of identifying and validating the individual identity 140 are described above.

Accordingly, the GUI 144 is presented on the client device 102 for interacting with the individual desktop 210. In this scenario, the individual desktop 210 includes a task switching control 602 that is selectable to invoke task switching functionality, such as for enabling switching among the shared desktop 212 and the applications 108. For instance, selecting the task switching control 602 invokes task switching functionality that causes a visual display of currently running applications or services selectable to enable a user to quickly switch to a different “task,” such as a different application or desktop experience.

In the scenario 600, selecting the task switching control 602 causes different available tasks to be presented as selectable panes 604 arranged in the GUI 144. The selectable panes 604, for example, each represent a different task or experience that can be selected and populated to the GUI 144. While task switching is depicted here as the selectable panes 604, it is to be appreciated that any technique for task switching functionality may be contemplated in implementations, such as a cascading layout of tasks, an exploded cluster of tasks, and so forth. Thus, the task switching control 602 represents functionality for enabling switching between open applications or services from a single interface, e.g., from the individual desktop 210. Generally, the task switching control 602 may be presented in various ways, such as a feature of the operating system 106, by the group platform module 130, and so forth.

According to various implementations, selection of one of the selectable panes 604 causes presentation of a particular task represented by the selected pane. For instance, selection of a selectable pane 604 that represents the shared desktop 212 will cause the group platform module 130 to present the shared desktop 212 on the GUI 144 either instead of or in addition to the individual desktop 210. Selection of the pane 604, for example, causes the shared desktop 212 to replace the selectable panes 604 in the GUI 144 such that a user may interact with the shared desktop 212. Thus, the task switching control 602 enables convenient and efficient switching among different available tasks, such as between presentation of the shared desktop 212, the individual desktop 210, and the applications 108.

Having discussed some example implementation scenarios, consider now a discussion of some example procedures in accordance with one or more embodiments.

The following discussion describes some example procedures for group data and priority in an individual desktop in accordance with one or more embodiments. The example procedures may be employed in the environment 100 of FIG. 1, the system 1000 of FIG. 10, and/or any other suitable environment. The procedures, for instance, represent example procedures for implementing the scenarios described above. In at least some implementations, the steps described for the various procedures are implemented automatically and independent of user interaction. According to various implementations, the procedures may be performed locally (e.g., at the client device 102) and/or at a network-based service, such as the group service 146. The procedures, for instance, represent functionality of the group platform module 130.

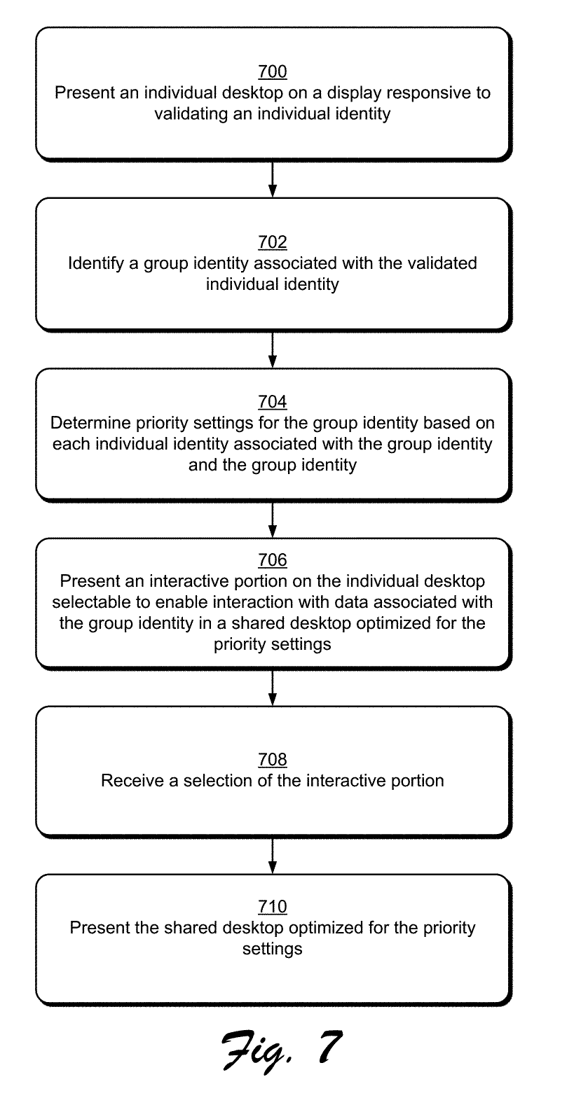

FIG. 7 is a flow diagram that describes steps in a method in accordance with one or more implementations. The method describes an example procedure for interacting with group data in an individual desktop in accordance with one or more implementations. In at least some implementations, the method may be performed at least in part at the client device 102 (e.g., by the group platform module 130) and/or by the group service 146.

Step 700 presents an individual desktop on a display responsive to validating an individual identity. Generally, an individual identity may be validated in various ways, such as by presence sensing that detects presence and identity of a user, user entry of credentials, and so forth. In some implementations, the individual identity 140 is obtained from the individual service 148. As a result, the individual desktop 210 is presented on the GUI 144 for interaction. Example ways of validating the individual identity 140 are discussed above.

Step 702 identifies a group identity associated with the validated individual identity. For instance, the group platform module 130 obtains the group identity 138 from the group service 146 over the network 104. Example ways of identifying the group identity 138 are discussed above.

Step 704 determines priority settings for the group identity based on each individual identity associated with the group identity and the group identity. Generally, the group platform module 130 determines the priority settings 142 in accordance with the group platform policies 136 implemented by the group platform module 130. For instance, the priority settings 142 are determined for each user from the group 132 relative to each other based on the individual identity 140, 206, 208 of each user and the group identity 138. Different ways of determining the priority settings 142 are described above.

Step 706 presents an interactive portion on the individual desktop selectable to enable interaction with data associated with the group identity in a shared desktop optimized for the priority settings. For instance, the group platform module 130 processes data 302 associated with the group identity 138 and enforces the priority settings 142. The interactive portion 306 discussed in the scenarios above, for instance, represents functionality to interact with the group data 304. In some implementations, the interactive portion 306 is an icon selectable to launch an instance of the shared desktop 212 associated with the group identity 138. According to various implementations, the interactive portion 306 enables sharing of individual data 404 from the individual desktop 210 to the group identity 138. According to one or more implementations, the instance of the shared desktop 212 may run on a computing device separate from the individual desktop 210.

Step 708 receives a selection of the interactive portion. The user 134, for instance, selects the interactive portion 306 using one or more of the input mechanisms 112. Examples of the input mechanisms 112 are described above.

Step 710 presents the shared desktop optimized for the priority settings. Responsive to selection of the interactive portion 306, for example, the group platform module 130 causes the shared desktop 212 to be presented in the GUI 144. The shared desktop 212, for example, is optimized to include the data associated with the group identity 138 and the individual identity 140 determined to have priority via the priority settings 142. In some implementations, the shared desktop 212 is optimized for user presence based on input from the presence sensors 126. According to various implementations, the shared desktop 212 is presented as a system shell within the individual desktop 210. Alternatively or additionally, presentation of the shared desktop 212 may replace the presentation of the individual desktop 210.

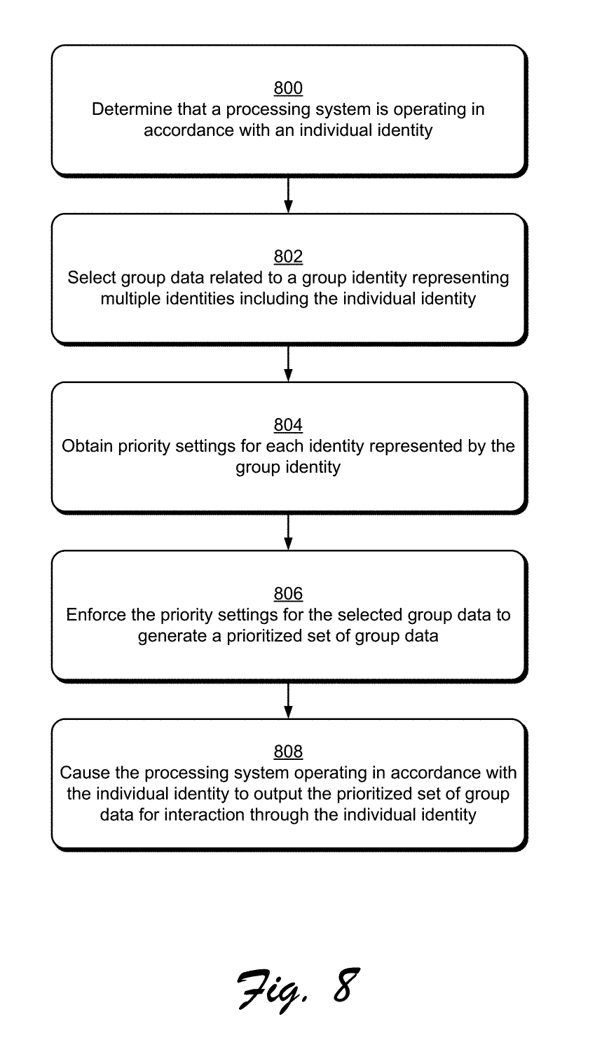

FIG. 8 is a flow diagram that describes steps in a method in accordance with one or more implementations. The method describes an example procedure for processing group data in an individual processing system in accordance with one or more implementations. In at least some implementations, the method may be performed at least in part at the client device 102 (e.g., by the group platform module 130) and/or by the group service 146.

Step 800 determines that a processing system is operating in accordance with an individual identity. In an example implementation, the operating system 106 of the client device 102 is determined to be running as the individual identity 140 as a result of validating the individual identity 140. Validation may be obtained, for instance, through the individual service 148 over the network 104.

Step 802 selects group data related to a group identity representing multiple identities including the individual identity. For instance, the group identity 138 represents the group 132 of individuals, each having their own individual identity 140, 206, 208. The group platform module 130, for example, receives and selects data 304 or content associated with the group identity 138 or the individual identities 140, 206, 208.

Step 804 obtains priority settings for each identity represented by the group identity. For instance, the group platform module 130 obtains the priority settings 142 from the group service 146 over the network 104. Example ways of obtaining the priority settings 142 are discussed above.

Step 806 enforces the priority settings for the selected group data to generate a prioritized set of group data. Generally, the group platform module 130 enforces the priority settings 142 in accordance with group platform policies 136, based on the group identity 138 and the individual identities 140, 206, 208 relative to one another. The group platform policies 136, for instance, specify which content to present and how to configure group data 304 for display based on factors associated with priority, identity, presence, and so forth. In some implementations, the priority settings 142 may be content and/or application-specific. Different ways of enforcing the priority settings 142 are described above.

Step 808 causes the processing system operating in accordance with the individual identity to output the prioritized set of group data for interaction through the individual identity. For instance, the group platform module 130 causes the client device 102 to output to the individual desktop 210 group data 304 for interaction with the individual identity 140 on the GUI 144. Generally, this permits the user 134 associated with the individual identity 140 to interact with the group data 304 through the GUI 144 optimized for the user 134. In some implementations, individual data 404 associated with the individual identity 140 can be shared to the group identity 138 as well.

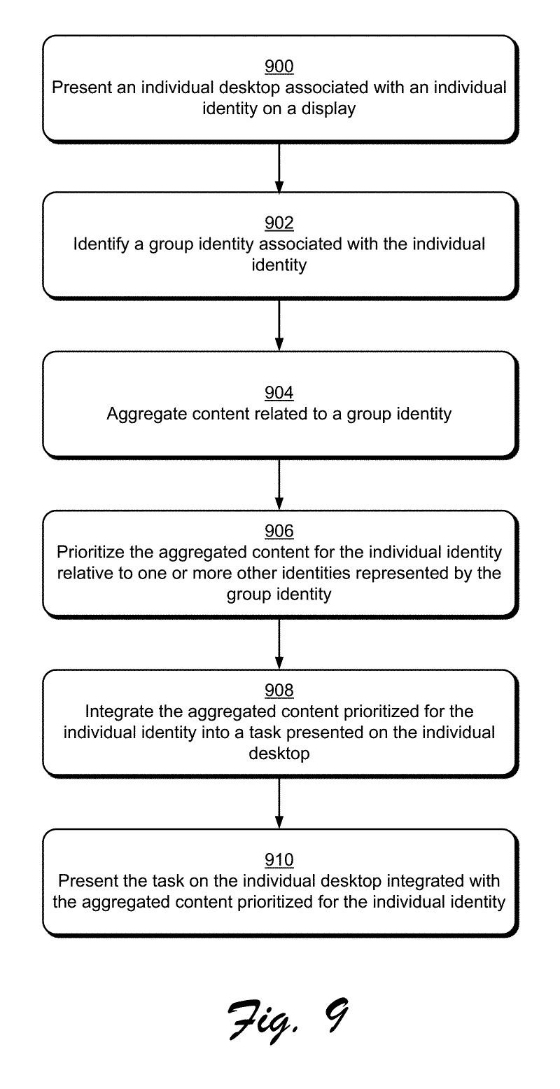

FIG. 9 is a flow diagram that describes steps in a method in accordance with one or more implementations. The method describes an example procedure for integrating group data in an individual desktop in accordance with one or more implementations. In at least some implementations, the method may be performed at least in part at the client device 102 (e.g., by the group platform module 130) and/or by the group service 146.

Step 900 presents an individual desktop associated with an individual identity on a display. For instance, the client device 102 presents the individual desktop 210 as the GUI 144 on the display device 116.

Step 902 identifies a group identity associated with the individual identity. For instance, the group platform module 130 obtains the group identity 138 from the group service 146 over the network 104. Example ways of identifying the group identity 138 are discussed above.

Step 904 aggregates content related to a group identity. The group platform module 130, for instance, aggregates content associated with the group identity 138. The content may be aggregated, for instance, by the group platform module 130. Additionally or alternatively, the content may be received from the group service 146 or the individual service 148. Example ways of aggregating content are discussed above.

Step 906 prioritizes the aggregated content for the individual identity relative to one or more other identities represented by the group identity. The group platform module 130, for instance, determines privileges for each user from the group 132 relative to each other based on the priority settings 142 and the group platform policies 136. The priority settings 142 are determined based on the individual identities 140, 206, 208 of each user from the group 132 and the group identity 138. Additionally, the priority settings 142 are enforced in accordance with the group platform policies 136.

Step 908 integrates the aggregated content prioritized for the individual identity into a task presented on the individual desktop. The task, for instance, represents one or more of an application or a service. For example, content aggregated by the group platform module 130 is integrated with one of the applications 108 (e.g., the calendar application 402) of the individual desktop 210. The applications 108 are associated with the individual identity 140 through the shared desktop 212, but are integrated with content associated with the group identity 138.

Step 910 presents the task on the individual desktop integrated with the aggregated content prioritized for the individual identity. The group platform module 130 processes aggregated content for presentation on the individual desktop 210 through applications 108, for instance. Generally, this permits the user 134 associated with the individual identity 140 to interact with group data through the GUI 144 optimized for the individual identity 140.

Having discussed some example procedures, consider now a discussion of an example system and device in accordance with one or more embodiments.

FIG. 10 illustrates an example system generally at 1000 that includes an example computing device 1002 that is representative of one or more computing systems and/or devices that may implement various techniques described herein. For example, the client device 102 discussed above with reference to FIG. 1 can be embodied as the computing device 1002. The computing device 1002 may be, for example, a server of a service provider, a device associated with the client (e.g., a client device), an on-chip system, and/or any other suitable computing device or computing system.

The example computing device 1002 as illustrated includes a processing system 1004, one or more computer-readable media 1006, and one or more Input/Output (I/O) Interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1010 and computer-readable media 1006 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules that are executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, a wearable device, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. For example, functionalities discussed with reference to the group platform module 134, the group service 146, and/or the individual service 148 may be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 1000.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A system for presenting group content in an individual environment, the system comprising: at least one processor; and one or more computer-readable storage media including instructions stored thereon that, responsive to execution by the at least one processor, cause the system to perform operations including: presenting an individual desktop on a display responsive to validating an individual identity; identifying a group identity associated with the validated individual identity; determining priority settings for the group identity based on each individual identity associated with the group identity and the group identity; presenting an interactive portion on the individual desktop selectable to enable interaction with data associated with the group identity in a shared desktop optimized for the priority settings; receiving a selection of the interactive portion; and responsive to said receiving the selection, presenting the shared desktop.

In addition to any of the above described systems, any one or combination of: wherein the shared desktop is accessible by a group of individual identities associated with the group identity; wherein the operations further include sharing content between the individual desktop and the shared desktop; wherein the shared desktop is configured as a welcome screen supporting content associated with the group identity and one or more individual identities associated with the group identity; wherein said presenting the shared desktop comprises presenting the shared desktop within the individual desktop; wherein the operations further include outputting a selectable control that is selectable to switch between presentation of the individual desktop and presentation of the shared desktop; wherein an instance of the shared desktop is presented on a display of a shared computing device separate from the individual desktop; wherein the group identity is created via a shared computing device; wherein the operations further include presenting a selectable control that enables switching from the presentation of the individual desktop to the presentation of the shared desktop or a presentation of one or more other individual desktops associated with the group identity; wherein the shared desktop includes content associated with the group identity including one or more of a calendar, notes, reminders, media, settings, notifications, or content from services or applications associated with the group identity; and further comprising presenting a selectable control that is selectable to switch between the shared desktop and one or more applications associated with the individual identity.

A computer-implemented method for presenting group content in an individual environment, the method comprising: determining that a processing system is operating in accordance with an individual identity; selecting group data related to a group identity representing multiple identities including the individual identity; obtaining priority settings for each identity represented by the group identity; enforcing the priority settings for the selected group data to generate a prioritized set of group data; and causing the processing system operating in accordance with the individual identity to output the prioritized set of group data for interaction through the individual identity.

In addition to any of the above described systems, any one or combination of: wherein the priority settings are based on the group identity and each identity represented by the group identity relative to one another; wherein said causing the processing system operating in accordance with the individual identity to output the prioritized set of group data for interaction through the individual identity comprises presenting an individual desktop including an interactive portion selectable to enable interaction with the group data from the individual desktop; and wherein said causing the processing system operating in accordance with the individual identity to output the prioritized set of group data for interaction through the individual identity comprises presenting an individual desktop including an interactive portion selectable to present a shared desktop associated with the group identity that enables interaction with the prioritized set of the group data.

A computer-implemented method for presenting group content in an individual environment, the method comprising: presenting an individual desktop associated with an individual identity on a display; identifying a group identity associated with the individual identity; aggregating content related to the group identity; prioritizing the aggregated content for the individual identity relative to one or more other identities represented by the group identity; integrating the aggregated content prioritized for the individual identity into one or more of an application or a service of the individual desktop; and presenting on the individual desktop the one or more of the application or the service integrated with the aggregated content prioritized for the individual identity.

In addition to any of the above described systems, any one or combination of: further comprising detecting the presence of a user associated with the individual identity via one or more presence sensors, wherein said presenting the individual desktop is responsive to said detecting the presence; wherein the one or more of the application or the service includes one or more of a calendar, notes, reminders, media, settings, or notifications; wherein said prioritizing comprises prioritizing the aggregated content based on application-specific priority settings; and further comprising presenting an interactive portion on the individual desktop that is selectable to enable sharing of the aggregated content to the group identity.

Techniques for group interaction are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system to perform operations including:
presenting an individual desktop on a display responsive to validating an individual identity;
identifying a group identity associated with the validated individual identity;
determining priority settings for the group identity based on each individual identity associated with the group identity and the group identity;
presenting an interactive portion on the individual desktop selectable to enable interaction with data associated with the group identity in a shared desktop optimized for the priority settings;
receiving a selection of the interactive portion; and
responsive to said receiving the selection, presenting the shared desktop.

2. A system as described in claim 1, wherein the shared desktop is accessible by a group of individual identities associated with the group identity.

3. A system as described in claim 1, wherein the operations further include sharing content between the individual desktop and the shared desktop.

4. A system as described in claim 1, wherein the shared desktop is configured as a welcome screen supporting content associated with the group identity and one or more individual identities associated with the group identity.

5. A system as described in claim 1, wherein said presenting the shared desktop comprises presenting the shared desktop within the individual desktop.

6. A system as described in claim 1, wherein the operations further include outputting a selectable control that is selectable to switch between presentation of the individual desktop and presentation of the shared desktop.

7. A system as described in claim 1, wherein an instance of the shared desktop is presented on a display of a shared computing device separate from the individual desktop.

8. A system as described in claim 1, wherein the group identity is created via a shared computing device.

9. A system as described in claim 1, wherein the operations further include presenting a selectable control that enables switching from the presentation of the individual desktop to the presentation of the shared desktop or a presentation of one or more other individual desktops associated with the group identity.

10. A system as described in claim 1, wherein the shared desktop includes content associated with the group identity including one or more of a calendar, notes, reminders, media, settings, notifications, or content from services or applications associated with the group identity.

11. A system as described in claim 1, further comprising presenting a selectable control that is selectable to switch between the shared desktop and one or more applications associated with the individual identity.

12. A computer-implemented method, comprising:
determining that a processing system is operating in accordance with an individual identity;
selecting group data related to a group identity representing multiple identities including the individual identity;
obtaining priority settings for each identity represented by the group identity;
enforcing the priority settings for the selected group data to generate a prioritized set of group data; and
causing the processing system operating in accordance with the individual identity to output the prioritized set of group data for interaction through the individual identity.

13. A method as in claim 12, wherein the priority settings are based on the group identity and each identity represented by the group identity relative to one another.

14. A method as in claim 12, wherein said causing the processing system operating in accordance with the individual identity to output the prioritized set of group data for interaction through the individual identity comprises presenting an individual desktop including an interactive portion selectable to enable interaction with the group data from the individual desktop.

15. A method as in claim 12, wherein said causing the processing system operating in accordance with the individual identity to output the prioritized set of group data for interaction through the individual identity comprises presenting an individual desktop including an interactive portion selectable to present a shared desktop associated with the group identity that enables interaction with the prioritized set of the group data.

16. A computer-implemented method, comprising:
presenting an individual desktop associated with an individual identity on a display;
identifying a group identity associated with the individual identity;
aggregating content related to the group identity;
prioritizing the aggregated content for the individual identity relative to one or more other identities represented by the group identity;
integrating the aggregated content prioritized for the individual identity into one or more of an application or a service of the individual desktop; and
presenting on the individual desktop the one or more of the application or the service integrated with the aggregated content prioritized for the individual identity.

17. A method as described in claim 16, further comprising detecting the presence of a user associated with the individual identity via one or more presence sensors, wherein said presenting the individual desktop is responsive to said detecting the presence.

18. A method as described in claim 16, wherein the one or more of the application or the service includes one or more of a calendar, notes, reminders, media, settings, or notifications.

19. A method as described in claim 16, wherein said prioritizing comprises prioritizing the aggregated content based on application-specific priority settings.

20. A method as described in claim 16, further comprising presenting an interactive portion on the individual desktop that is selectable to enable sharing of the aggregated content to the group identity.
